(19) United States
(12) Patent Application Publication
(10) Pub. No.: US 2008/0153605 A1
(43) Pub. Date: Jun. 26, 2008

(54) BUFFER ADAPTER FOR TRANSMITTING ROTARY MOTION

(75) Inventor: Su-Chen LIAO, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: TAIWAN LONG HAWN ENTERPRISE CO., TAICHUNG CITY (TW)

(21) Appl. No.: 11/835,776

(22) Filed: Aug. 8, 2007

(30) Foreign Application Priority Data
Dec. 26, 2006 (TW) 95222862

(51) Int. Cl. F16D 3/00

(52) U.S. Cl. 464/58

(57) ABSTRACT

An adapter for connection between a rotary driving shaft, for example an output shaft of a motor, and a load device for buffering resistance force fed back from the load device includes a supporting member, a first shaft pivotally mounted in the supporting member and connectable to the load device, a second shaft pivotally mounted in the supporting member, coaxially aligned with the first shaft and connectable to the rotary driving shaft, and a spiral spring having an outer end connected with the first shaft and a center end connected with the second shaft. Thus, the spiral spring can provides a buffering effect to the resistance force fed back from the load device to the rotary driving shaft.

### BACKGROUND OF THE INVENTION

1. Field of the Invention

The present invention relates generally to an adapter connectable between a rotary driving shaft, for example an output shaft of a motor, and a load device for transmitting rotary motion therethrough, and more specifically to such an adapter having means for buffering resistance force fed back from the load device to the rotary driving shaft.

2. Description of the Related Art

In general, an output shaft of a motor and a load device for doing work on a workpiece are coupled with each other through a rigid rod or a flexible steel wire such that the output power of the motor can be transmitted to the load device through the rod or the flexible wire, thereby driving the load device to work on the workpiece.

On the one hand, in the condition that the output shaft of the motor and the load device are coupled with each other through the rigid rod, the load device and the output shaft of the motor will immediately simultaneously stop rotating when the load device is encountered with a resistance force that surpasses the output power of the motor. However, the motor is keeping driving the output shaft at this time, and therefore the motor will be damaged easily.

On the other hand, in the condition that the output shaft of the motor and the load device are coupled with each other through the steel wire, the output shaft of the motor can still drive the steel wire to rotate due to the flexibility of the steel wire even though the load device is encountered with an extreme resistance force to stop rotating. Under this circumstance, because one end of the steel wire, which is connected with the load device, is held stationary and the other end of the steel wire rope, which is connected with the output shaft of the motor, is still driven by the output shaft of the motor to rotate, the steel wire will be twisted, resulting in irregular deformation of the steel wire. Although the motor can gradually stop running by means of the deformation of the steel wire to prevent the motor from damaging, the steel wire may not effectively regularly slow down the motor speed. Further, the steel wire may be permanently deformed such that the output shaft of the motor and the load device may be imperfectly coupled to each other, resulting in that the power may not be completely transmitted from the output shaft to the load device or an exceeding vibration may be generated during power transmitting operation.

### SUMMARY OF THE INVENTION

The present invention has been accomplished in view of the above-noted circumstances. It is one objective of the present invention to provide a buffer adapter, which is connectable between a rotary driving shaft, for example an output shaft of a motor, and a load device for providing a buffering effect to effectively alleviate a resistance force fed back from the load device to the rotary shaft.

It is another objective of the present invention to provide a buffer adapter, which is connectable between a rotary driving shaft and a load device and can provide an additional effort force to the load device when the load device is encountered with a resistance force.

To achieve these objectives of the present invention, an adapter, which is used to be connected between a rotary shaft and a load device for transmitting a rotary motion therethrough, comprises a supporting member, a first shaft pivotally mounted in the supporting member, a second shaft pivotally mounted in the supporting member and coaxially aligned with the first shaft, and a spiral spring having an outer end connected with the first shaft and a center end connected with the second shaft. When the load device is encountered with a resistance force exceeding the effort force of the rotary driving shaft, the spiral spring can effectively alleviate the resistance force fed back from the load device to the rotary driving shaft and exert an additional effort force to the load device by means of its elastic return force.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded view of a buffer adapter according to a preferred embodiment of the present invention;

FIG. 2 is a perspective view of the buffer adapter according to the preferred embodiment of the present invention;

FIG. 3 is a sectional view taken along line 3-3 of FIG. 2;

FIG. 4 is a sectional view taken along line 4-4 of FIG. 2, and

FIG. 5 is similar to FIG. 4 but showing that the spiral spring is rolled tight.

### DETAILED DESCRIPTION OF THE INVENTION

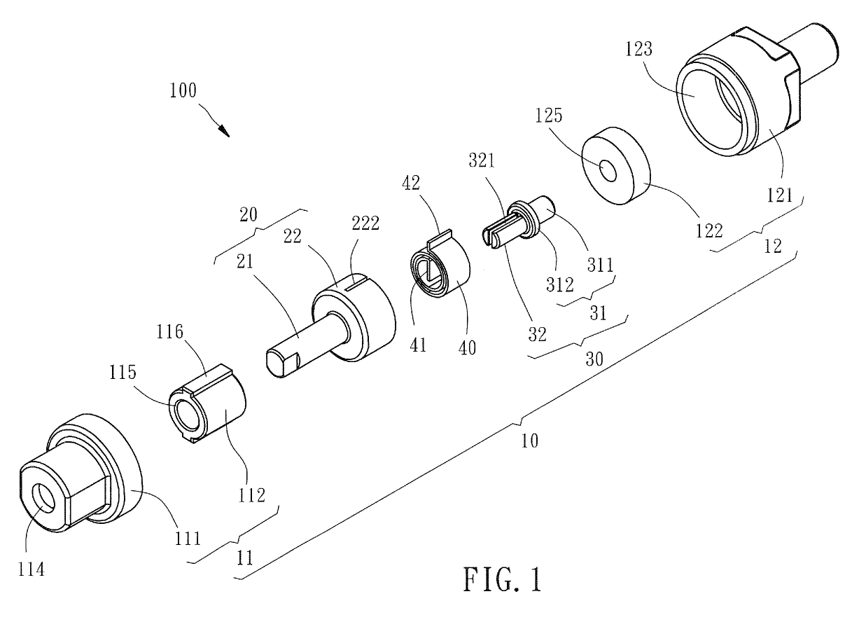

Referring to FIG. 1 to FIG. 3, an adapter 100 in accordance with a preferred embodiment of the present invention, which is adapted to be connected between a rotary driving shaft, which can be, for example but not limited to, an output shaft of a motor, and a load device for transmitting a rotary motion therethrough for enabling the load device to do work on a workpiece, comprises a supporting member 10, a first shaft 20, a second shaft 30 and a spiral spring 40.

The supporting member 10 comprises a First base 11 and a second base 12. The first base 11 includes a first housing 111 provided at one end thereof with a first accommodation chamber 113 inside, two opposite first insertion grooves (not shown) formed on an inner periphery of the accommodation chamber 113, and a first hole 114 at the other end thereof, which is in communication with the first accommodation chamber 113 and smaller in diameter than the first accommodation chamber 113 so as to form a first stepped portion 117 therebetween, and a first bearing 112 mounted in the first accommodation chamber 113 of the first housing 111 with one end thereof contacted with the first stepped portion 117 of the first housing 111. The first bearing 112 is provided with a center hole 115 passing through two opposite ends thereof and being in communication with the first hole 114 of the first housing 111, and two first insertion blocks 116 at an outer periphery thereof respectively inserted into the first insertion grooves of the first housing 111 such that the first bearing 112 can be fixed in the first accommodation chamber 113 of the first housing 111. The second base 12 includes a second housing 121 provided at one end thereof with a second accommodation chamber 123 inside and a second hole 124 at the other end thereof, which is in communication with the second accommodation chamber 123 and smaller in diameter than the second accommodation chamber 123 so as to form a second stepped portion 127 therebetween, and a second bearing 122 mounted in the second accommodation chamber 123 of the second housing 121 with rear side thereof contacted with the second stepped portion 127 and provided with a center hole 125 passing through two opposite sides thereof and being in communication with the second hole 124 of the second housing 121.

The first shaft 20 includes a first rod 21 running through the center hole 115 of the first bearing 112 and the first hole 114 of the first housing 111 and having a front end thereof extending out of the first hole 114 of the first housing 111, and a first coupling portion 22 integrally connected with a rear end of the first rod 21 and provided with a receiving chamber 221 inside and a first slot 222 at an periphery of the receiving chamber 221.

The second shaft 30 is coaxially aligned with the first shaft 20 and includes a second rod 31 having a rod body 311 penetrating through the center hole 125 of the second bearing 122 and an annual protrusion 312 leaned against a front side of the second bearing 122 when the rod body 311 penetrates through the center hole 125 of the second bearing 122, and a second coupling portion 32 integrally connected with the second rod 31 and provided with a second slot 321.

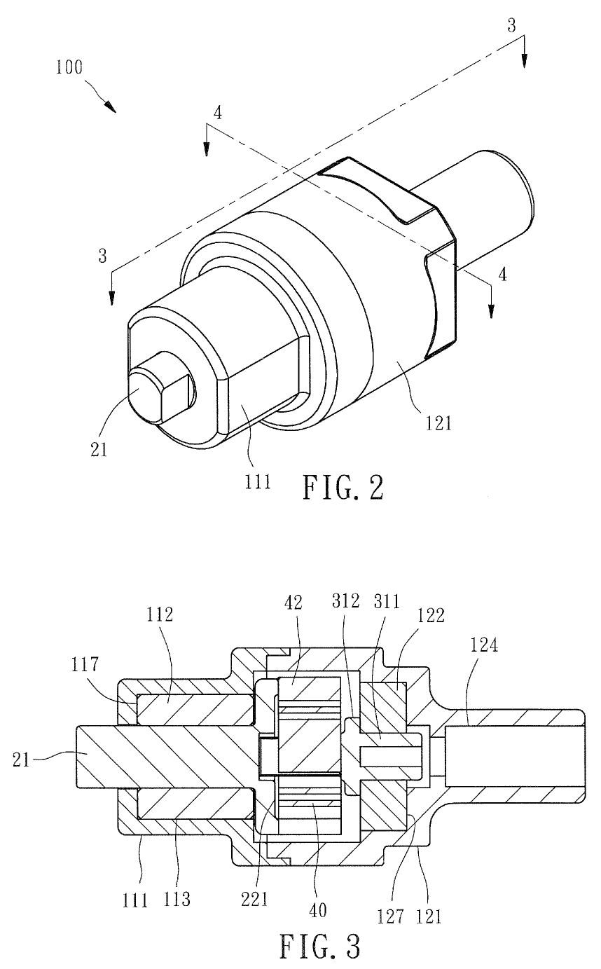

The spiral spring 40 is formed by rolling a metal piece into a spiral shape. The spiral spring 40 is received in the receiving chamber 221 of the first shaft 20 and has a center end 41 inserted into the second slot 321 of the second shaft 30 and an outer end 42 inserted into the first slot 222 of the first shaft 20. Thereafter, the first housing 111 and the second housing 121 can be assembled together to form the adapter 100, as shown in FIG. 2 and FIG. 3.

By means of the aforesaid design, the first rod 21 of the first shaft 20 and the second rod 31 of the second shaft 30 can be respectively rotated in the center hole 115 of the first bearing 112 and the center hole 125 of the second bearing 122 by an external force, and the first shaft 20 and the second shaft 30 are coaxially aligned with each other.

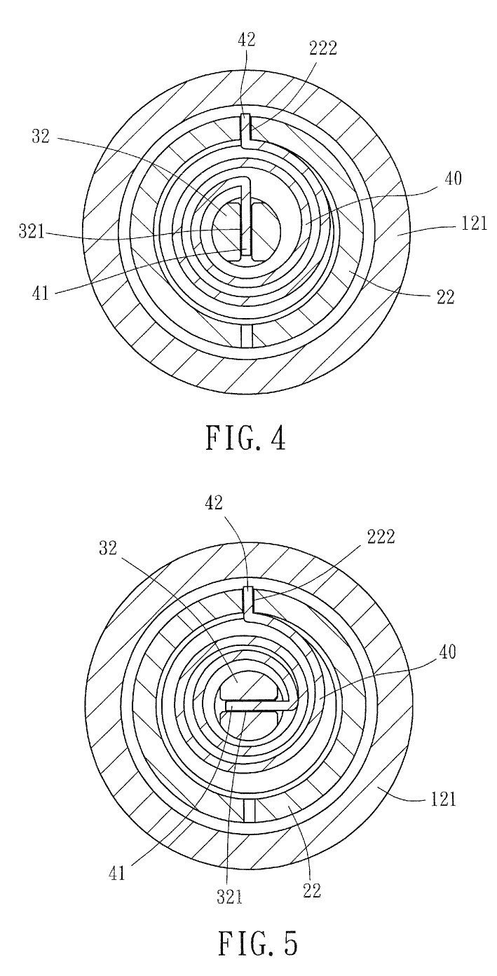

When the adapter 100 is in use, the first rod 21 of the first shaft 20 and the second rod 31 of the second shaft 30 are respectively connected with, for example but not limited to, a load device (not shown) and an output shaft of a motor (not shown) such that the power generated by the motor can be transmitted from the output shaft to the load device through the second shaft 30, the spiral spring 40 and the first shaft 20. In other words, when the second shaft 30 is driven by the output shaft of the motor to rotate, the first shaft 20 can be synchronously rotated through the spiral spring 40 such that the load device connected with first shaft 20 can work on a workpiece. Under this circumstance, the spiral spring 40 is in a normal condition, as shown in FIG. 4. When the load device is encountered with a resistance force that surpasses the output power of the motor, the load device and the first shaft 20 will stop rotating. However, since the first shaft 20 and the second shaft 30 are coupled with each other through the spiral spring 40, the second shaft 30 can be driven by the output shaft of the motor to rotate even though the first shaft 20 stops rotating. Thus, as the second shaft 30 is keeping rotating, the outer end 42 of the spiral spring 40 connected with the first shaft 20 is stationary, and the center end 41 of the spiral spring 40 is driven by the second shaft 30 to wind about a center of the spiral spring 40, as shown in FIG. 5, an elastic return force will be stored in the spiral spring 40 and exert on the first shaft 20. As a result, if the elastic return force provided by the spiral spring 40 and the output power of the motor, which exert on the first shafts 20 together, overcome the resistance force received by the load device, the load device can be driven to rotate so as to work on the workpiece again.

In addition, if the sum of the elastic return force provided by the spiral spring 40 and the output power of the motor cannot overcome the resistance force received by the load device, the second shaft 30 will gradually slow down its speed in rotation due to the resistance force of rolling tight the spiral spring 40, thereby providing a buffering effect to the first shaft 20 and the second shaft 30.

Accordingly, in addition to the output power provided by the motor, the adapter of the present invention can further give the elastic return force provided by the spiral spring 40 to the load device for enabling the load device to keep working. In addition, the adapter of the present invention can also provide a buffering effect to the first shaft and the second shaft to gradually slow down the rotary motion of the second shaft while the first shaft stops rotating so as to prevent the first shaft and the second shaft from damaging.

Furthermore, in the above-disclosed embodiment, the first shaft is connected to the load device and the second shaft is connected to the output shaft of the motor. However, this is for illustrative purpose only and has no intention to limit the present invention. That is, the first shaft can be connected to a rotary driving shaft, for example an output shaft of a motor and the second shaft can be connected to a load device in practice.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An adapter connectable between a rotary driving shaft and a load device, comprising:
a supporting member;
a first shaft pivotally mounted in the supporting member;
a second shaft pivotally mounted in the supporting member and coaxially aligned with the first shaft; and
a spiral spring having an outer end connected with the first shaft and a center end connected with the second shaft.

2. The adapter as claimed in claim 1, wherein the supporting member includes a first base for installation of the first shaft and a second base coupled to the first base for installation of the second shaft.

3. The adapter as claimed in claim 1, wherein the supporting member comprises a first base including a first housing, which has a first accommodation chamber inside and a first hole in communication with the first accommodation chamber, and a first bearing, which is mounted in the first accommodation chamber of the first housing and has a center hole through which the first shaft is inserted, and a second base including a second housing, which has a second accommodation chamber inside and a second hole in communication with the second accommodation chamber, and a second bearing, which is mounted in the second accommodation chamber of the second housing and has a center hole through which the second shaft is inserted.

4. The adapter as claimed in claim 1, wherein the first shaft includes a first rod pivotally mounted in the supporting member and a first coupling portion with a first slot for insertion of the outer end of the spiral spring, and the second shaft includes a second rod pivotally mounted in the supporting member and a second coupling portion with a second slot for insertion of the center end of the spiral spring.

5. The adapter as claimed in claim 4, wherein the first coupling portion of the first shaft has a receiving chamber for accommodation of the spiral spring.
